(19) United States
(12) Patent Application Publication
(10) Pub. No.: US 2010/0041295 A1
(43) Pub. Date: Feb. 18, 2010

(54) LAMINATE COMPRISING FILM AND WEB BASED ON THERMOPLASTIC POLYURETHANE

(75) Inventors: Hauke Malz, Diepholz (DE); Frank Uhlhorn, Drebber (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/521,810

(22) PCT Filed: Jan. 10, 2008
(86) PCT No.: PCT/EP2008/050232

§ 371 Date: Jun. 30, 2009

(30) Foreign Application Priority Data
Jan. 17, 2007 (EP) 07100698.5

(51) Int. Cl. D04H 13/00; B32B 27/40; B32B 37/00; B29C 49/04

(52) U.S. Cl. 442/335; 442/394; 442/334; 156/60; 156/244.21

(57) ABSTRACT

A laminate comprises bonded together adheringly
(i) film based on a thermoplastic polyurethane based on a polyetherdiol prepared by alkoxylation of a difunctional starting substance, ethylene oxide being used as alkylene oxide and the weight fraction of ethylene oxide based on the total weight of the alkylene oxides used being at least 20% by weight, and also
(ii) fibrous nonwoven web based on thermoplastic polyurethane.

The present invention relates to a laminate comprising bonded together adheringly
(i) film based on a thermoplastic polyurethane based on a polyetherdiol prepared by alkoxylation of a difunctional starting substance, ethylene oxide being used as alkylene oxide and the weight fraction of ethylene oxide based on the total weight of the alkylene oxides used being at least 20% by weight, and also
(ii) fibrous nonwoven web based on thermoplastic polyurethane.

The present invention further concerns processes for producing the laminates of the present invention and also garments, in particular outerwear, footwear and medical/medicinal articles, preferably bandages and wound contact materials, comprising the laminates of the present invention.

Endowing garments and shoes with breathable, i.e., water vapor permeable but wind- and waterproof, membranes to protect the wearer from the weather while ensuring a pleasant wear comfort, is common knowledge. Goretex® membranes have become synonymous for such products. However, the Goretex® membrane has the disadvantage that it is constructed from a costly and difficult-to-handle Teflon membrane and a polyurethane layer. This made processing complicated and recycling as a single material impossible. Cheaper developments utilize water vapor permeable films of thermoplastic polyurethane (TPU). But these films process badly in some instances. For instance, their low tongue tear strength compared with a textile meant they could not be stitched into a garment, but had to be incorporated by means of a costly laminating step. Lamination onto material of a different type again meant that any possible recycling was foreclosed. In addition, the films had no textile character, for example textile haptics, reducing wear comfort.

It is an object of the present invention to develop a membrane for application in footwear or garments in particular that is very windproof and waterproof and also breathable, i.e., water vapor permeable, has textile character, is easy to process and is ideally made of one material of construction.

We have found that this object is achieved by the laminates set forth at the beginning, in particular the present invention's garments, footwear and medical/medicinal articles comprising said laminates.

The laminates of the present invention pair a haptically pleasant, textile but open-pore fibrous nonwoven web of good heat resistance with a breathable and water-impermeable film. Such a laminate possesses very good breaking strength coupled with high elasticity and hence all the prerequisites to be useful as an alternative apparel outerwear material, footwear and medical/medicinal articles such as bandages and wound contact materials. In addition, the membranes consist of one material of construction, namely TPU, and so are recyclable in their entirety.

Both the components of the present invention's laminate comprise preferably consist of thermoplastic polyurethane. Thermoplastic polyurethane is well known as a material of construction. Thermoplastic polyurethanes are polyurethanes which, when repeatedly heated and cooled in the temperature range typical for processing and using the material of construction, remain thermoplastic. Thermoplastic in relation to a polyurethane describes the polyurethane's property of, in a temperature range between 150° C. and 300° C. typical for the polyurethane, repeatedly softening when hot and hardening when cold and, in the softened state, repeatedly being moldable into intermediate or final articles as a molded, extruded or formed part.

The thermoplastic polyurethane used for the film (i) and the web (ii) is preferably obtainable by reaction of (a) isocyanates with (b) isocyanate-reactive compounds, preferably having a number average molecular weight in the range from 500 to 10,000 g/mol and, if appropriate, (c) chain extenders having a molecular weight in the range from 50 to 499 g/mol, if appropriate in the presence of (d) catalysts and/or (e) auxiliary materials. The respective starting materials are well known and commercially available. The thermoplastic polyurethane as such typically has a density in the range from 800 to 1500 grams per liter (g/l), preferably of 1000 to 1300 g/l.

The TPUs can be prepared by known processes continuously, for example by one shot or the prepolymer process using reaction extruders or the belt process, or batchwise by the familiar prepolymer operation. In these processes, the components (a), (b) and if appropriate (c), (d) and/or (e) which are made to react can be mixed with each other in succession or simultaneously, the reaction ensuing immediately. In the extruder process, the building block components (a), (b) and also, if appropriate, (c), (d) and/or (e) are introduced into the extruder individually or as a mixture, reacted for example at temperatures from 100 to 280° C. and preferably 140 to 250° C., and the TPU obtained is extruded, cooled and pelletized.

The components (a), (b) and also, if appropriate, (c), (d) and/or (e) customarily used in the preparation of polyurethanes will now be described by way of example:

a) Useful organic isocyanates (a) include commonly known aliphatic, cycloaliphatic, araliphatic and/or aromatic isocyanates, examples being hexamethylene diisocyanate (HDI), 2,2′-, 2,4′- and/or 4,4′-diphenylmethane diisocyanate (MDI), hydrogenated MDI (HMDI), ethylenediphenylene diisocyanate (EDI). Preference is given to using HDI and/or 4,4′-MDI, more preferably 4,4′-diphenylmethane diisocyanate.

b) Useful isocyanate-reactive compounds (b) include, in the case of the film in addition to the present invention's polyetherdiols, the commonly known isocyanate-reactive compounds, examples being polyesterols, polyetherols and/or polycarbonatediols, which are customarily also subsumed under the term polyols. These typically have a number average molecular weight in the range from 500 to 8000 g/mol, preferably in the range from 600 to 5000 g/mol and especially in the range from 800 to 3000 g/mol. They further typically have an average functionality in the range from 1.8 to 2.3, preferably in the range from 1.9 to 2.1 and in particular of 2. Average functionality preferably refers to the average number of OH groups per polyol molecule. When polyether alcohols are used as (b), these are generally prepared by known processes, for example by anionic polymerization with alkali metal hydroxides as catalysts and in the presence of a starter molecule comprising a plurality of reactive hydrogen atoms in attachment, from one or more alkylene oxides selected from propylene oxide (PO) and ethylene oxide (EO).

As constituent (b) it is also possible to use polyetherols obtained by ring-opening polymerization of tetrahydrofuran. These polytetrahydrofurans preferably have a functionality of about 2. They further preferably have a number average molecular weight in the range from 500 to 4000 g/mol, preferably in the range from 700 to 3000 g/mol and more preferably in the range from 900 to 2500 g/mol. Polytetrahydrofuran (=PTHF) is also known in the art under the designations of tetramethylene glycol (=PTMG), polytetramethylene glycol ether (=PTMEG) or polytetramethylene oxides (=PTMOs).

When polyester alcohols are used as constituent (b), they are typically prepared by condensation of polyfunctional alcohols having 2 to 12 carbon atoms and preferably 2 to 6 carbon atoms with polyfunctional carboxylic acids having 2 to 12 carbon atoms, examples being succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalene dicarboxylic acids.

A preferred embodiment utilizes a constituent (b) comprising a polyesterol having a number average molecular weight in the range from more than 400 to 5000 g/mol, preferably in the range from more than 500 to 3000 g/mol and more preferably in the range from 1000 to 2500 g/mol.

Particularly preferred polyols are PTHF and also polyesterols based on adipic acid, especially polyesterols obtainable by condensation of adipic acid with 1,4 butanediol, 1,2 ethylene glycol, 2-methylpropane-1,3-diol or 3-methyl-1,5 diol or mixtures thereof.

c) Useful chain extenders (c) include commonly known aliphatic, araliphatic, aromatic and/or cycloaliphatic compounds having a molecular weight in the range from 50 to 499, preferably 2-functional compounds, examples being diamines and/or alkanediols having 2 to 10 carbon atoms in the alkylene radical, in particular 1,4-butanediol, 1,6-hexanediol and/or di-, tri-, tetra-, penta-, hexa-, hepta-, octaalkylene glycols having 3 to 8 carbon atoms, preferably the corresponding oligo- and/or polypropylene glycols, including mixtures of chain extenders. Particular preference is given to using dialcohols as chain extenders, 1,4 butanediol being used in particular.

d) Useful catalysts, which accelerate in particular the reaction between the NCO groups of the diisocyanates (a) and the hydroxyl groups of the building block components (b) and (c), are compounds known in the prior art. Examples thereof are tertiary amines and also, in particular, organic metal compounds such as titanic esters, iron compounds such as for example iron-(i) acetylacetonate, tin compounds, examples being tin diacetate, tin dioctoate, tin dilaurate or the tin dialkyl salts of aliphatic carboxylic acids such as dibutyltin diacetate, dibutyltin dilaurate or the like. Preference is given to using organic metal compounds, in particular tin dioctoate. When the isocyanate is an aliphatic isocyanate, the tin dioctoate is used in concentrations from 10 ppm to 1000 ppm, in particular of 100-500 ppm. When the isocyanate is an aromatic isocyanate, the tin dioctoate is used in concentrations of 0.01-100 ppm, preferably 0.1-10 ppm and more preferably 0.5-5 ppm.

e) As well as catalysts (d), auxiliaries (e) can also be added to the building block components (a) to (c). Useful auxiliaries include for example surface-active substances, fillers, flame retardants, nucleating agents, antioxidants, gliding and demolding aids, dyes and pigments, if appropriate in addition to the present invention's stabilizer mixtures further stabilizers, for example against hydrolysis, light, heat or discoloration, inorganic and/or organic fillers, reinforcing agents and plasticizers. In a preferred embodiment, component (e) also includes hydrolysis stabilizers such as, for example, polymeric and low molecular weight carbodiimides.

As well as the specified components (a) and (b) and, if appropriate, (c), (d) and (e), chain regulators, customarily having a molecular weight in the range from 31 to 499, can also be used. Such chain regulators are compounds which have only one isocyanate-reactive functional group, examples being monofunctional alcohols, monofunctional amines and/or monofunctional polyols. Such chain regulators make it possible to adjust flow behavior in the case of TPUs in particular to specific values. Chain regulators can be used in general in an amount of 0 to 5 parts and preferably 0.1 to 1 part by weight based on 100 parts by weight of component (b), and by definition come within component (c). The conversion to the thermoplastic polyurethane preferably takes place in the absence of blowing agents. The thermoplastic polyurethane obtained is thus preferably a compact thermoplastic polyurethane. All molecular weights cited herein have the unit [g/mol].

To adjust the hardness of the TPUs, the building block components (b) and (c) can be varied within relatively wide molar ratios. Useful are molar ratios of component (b) to total of chain extenders (c) in the range from 10:1 to 1:10 and in particular in the range from 1:1 to 1:4, TPU hardness increasing with increasing (c) content.

The reaction can be carried out at customary characteristics, for example in the range from 800 to 1100. The characteristic is defined by 1000 times the ratio of total isocyanate groups of component (a) in the reaction to the isocyanate-reactive groups, i.e., the active hydrogens, of components (b) and (c). When the characteristic is 1000, there is one active hydrogen atom, i.e., one isocyanate-reactive function, on the part of the components (b) and (c) per isocyanate group of component (a). At characteristics above 1000, there will be more isocyanate groups than OH groups. Preference is given to using a characteristic of 970-1050 and more preferably 980-1020. A characteristic below 1000 can be advantageous since the molar mass of the TPU is reduced as a result and hence the melt flow index rises into a range preferred for processing.

Following this general description of TPUs, their preferred embodiments, starting materials and methods of making will now be set out with regard to the film (i) and the web (ii).

Film (i) based on thermoplastic polyurethane

Useful films based on thermoplastic polyurethane, herein also referred to as TPU, include according to the present invention films based on thermoplastic polyurethane based on polyetherdiols prepared by alkoxylation of difunctional starting substances, ethylene oxide being used as an alkylene oxide and the weight fraction of ethylene oxide based on the total weight of the alkylene oxides used being at least 20% by weight, preferably at least 50% by weight, more preferably at least 80% by weight. The film (i) is preferably based on the reaction of (a) isocyanate with polyetherdiol preferably having a number average molecular weight between 500 g/mol and 8000 g/mol prepared by alkoxylation of difunctional starting substances with ethylene oxide and propylene oxide as alkylene oxides, more preferably prepared by alkoxylation of difunctional starting substances with ethylene oxide as sole alkylene oxide. Preferably, the film (i) is based on the reaction of (a) MDI with (b) polyetherdiol and (c) butanediol. The thickness of the film is preferably between 10 μm and 200 μm, more preferably between 20 μm and 100 μm, in particular between 20 μm and 50 μm. The film (i), i.e., the TPU of film (i), preferably has a hardness between 60 Shore A and 74 Shore D, more preferably between 75 Shore A and 95 Shore A and in particular between 80 Shore A and 85 Shore A. Preferably, the film (i) utilizes a water vapor permeable TPU whose water vapor transmission rate is preferably greater than 1.5 mg/cm² preferably to DIN 53122-1. The production of appropriate film in particular by known extrusion of thermoplastic polyurethane is well known.

Fibrous nonwoven web based on thermoplastic polyurethane

A fibrous nonwoven web, herein also referred to as just nonwoven, is a layer, web and/or lap of directionally aligned or randomly disposed fibers, consolidated by friction and/or cohesion and/or adhesion.

Paper or articles of manufacture which have been woven, knit, tufted, stitch bonded through incorporation of binding yarns, or filaments, or felted by a wet-fulling operation are preferably not treated as nonwovens for the purposes of this invention.

In one preferred embodiment, a material is to be deemed a nonwoven for the purposes of this invention when more than 50% and more preferably between 60% and 90% by weight of the total weight of its fibrous constituents consist of fibers having a length to diameter ratio of greater than 300 and more preferably greater than 500.

In one preferred embodiment, the diameters of the individual fibers of the nonwoven are in the range from 100 μm to 0.1 μm, preferably in the range from 50 μm to 0.5 μm and particularly in the range from 10 μm to 0.5 μm.

In one preferred embodiment, the thickness of the nonwovens is in the range from 0.01 to 5 millimeters (mm), more preferably in the range from 0.1 to 2 mm and even more preferably in the range from 0.15 to 1.5 mm, measured to ISO 9073-2.

In one preferred embodiment, the mass per unit area of the nonwovens is between 10 and 1000 g/m², more preferably between 20 and 500 g/m² and even more preferably between 30 and 100 g/m², measured to ISO 9073-1.

The nonwoven may additionally be mechanically consolidated. Mechanical consolidation may take the form of one-sided or both-sided mechanical consolidation; both-sided mechanical consolidation is preferred. The nonwoven may additionally be chemically consolidated. In chemical consolidation, the nonwoven is consolidated by addition of chemical auxiliary material, for example an adhesive. In addition to the afore-described mechanical and chemical consolidation, the nonwoven may further be thermally consolidated. Thermal consolidation may be effected for example by subjecting the nonwoven to a treatment with hot air. When the nonwoven is consolidated, it is preferably consolidated thermally.

The nonwoven (ii) may have the following four parameters (P1 to P4) in preferred embodiments:

P1) An embodiment utilizes a nonwoven which has a machine direction tensile strength in the range from 5 newtons (N) per 5 cm to 1000 N per 5 cm, preferably in the range from 40 N per 5 cm to 1000 N per 5 cm (measured to DIN EN 12127).

P2) An embodiment utilizes a nonwoven which has a cross direction tensile strength in the range from 5 newtons (N) per 5 cm to 1000 N per 5 cm, preferably in the range from 20 N per 5 cm to 1000 N per 5 cm, and in particular of 40-1000 N per 5 cm (measured to DIN EN 12127).

P3) An embodiment utilizes a nonwoven which has a machine direction extension in the range from 10% to 800%, preferably in the range from 50% to 800% and especially in the range from 250% to 800%, measured to DIN EN 29073 Part 3.

P4) An embodiment utilizes a nonwoven which has a cross direction extension in the range from 10% to 800%, preferably in the range from 50% to 800% and especially in the range from 250% to 800%, measured to DIN EN 29073 Part 3.

In a preferred embodiment, the nonwoven comprises at least two, more preferably at least 3 and especially all the P1 to P4 features.

The utilized nonwoven is of thermoplastic polyurethane. This is to be understood as meaning that the utilized nonwoven comprises a thermoplastic polyurethane, preferably as an essential constituent. A preferred embodiment utilizes a nonwoven comprising thermoplastic polyurethane in an amount of 60% by weight to 100% by weight, more preferably of more than 80% by weight and especially more than 95% by weight, based on the total weight of the nonwoven.

As well as thermoplastic polyurethane, the utilized nonwoven may further comprise other polymers or auxiliaries, examples being polypropylene or copolymers of polypropylene, polyethylene or copolymers of polyethylene and/or polystyrene and/or copolymers of polystyrene such as styrene-acrylonitrile copolymers.

In one preferred embodiment, the thermoplastic polyurethane used for producing the nonwoven has a Shore hardness between 50 Shore A and 54 Shore D and more preferably between 70 Shore A and 90 Shore A, measured to DIN 53505.

There are many applications where the lighffastness of the nonwovens is of importance. Even when the fibrous nonwoven web merely serves as a support, it may be that the finish is not thick enough to filter out all the UV light. For this reason, aliphatic nonwovens, i.e., nonwovens based on aliphatic isocyanates, are preferred in those cases.

The nonwovens comprising thermoplastic polyurethanes can typically be produced from above-described thermoplastic polyurethane by the conventional “meltblown process” or “spunbond process”. “Meltblown processes” and “spunbond processes” are known to those skilled in the art. The nonwovens which are formed in the processes generally differ in terms of their mechanical properties and their consistency. Nonwovens produced by the spunbond process are particularly stable both horizontally and vertically, but have an open-celled structure. Nonwovens produced by the meltblown process have a particularly dense network of fibers and hence form a very effective barrier to liquids.

It is also possible to produce nonwovens by combining the meltblown process and the spunbond process. These nonwovens have a particularly dense network of fibers and a very good barrier to liquids and possess very good mechanical properties. Preference is given to producing nonwovens by combining the meltblown and spunbond processes.

It is particularly preferable for the laminate of the present invention to utilize a fibrous nonwoven web (ii) produced by the meltblown process.

To produce a TPU nonwoven by the meltblown process, a commercial plant for producing meltblown nonwovens can be used. Such plant is available from Reifenhäuser of Germany for example.

Typically, in a meltblown process, the TPU is melted in an extruder and fed by means of customary ancillaries such as melt pumps or filters to a spinning manifold. Here, the polymer generally flows through nozzles and, at the nozzle exit, is attenuated by an airstream to form a filament. The attenuated filaments are typically laid down on a drum or belt and forwarded.

A preferred embodiment utilizes a single-screw extruder having a compression ratio of 1:2-1:3 and particularly preferably 1:2-1:2.5. It is preferable to employ in addition a three-zone screw having a length to diameter (L/D) ratio of 25-30. The three zones are preferably equal in length. The three-zone screw preferably has throughout a constant pitch of 0.8-1.2 D and particularly preferably 0.95-1.05 D. The clearance between the screw and the barrel is >0.1 mm, preferably 0.1-0.2 mm. When a barrier screw is used as extruder screw, it is preferable to employ an overflow gap >1.2 mm. When the screw is equipped with mixing elements, these mixing elements are preferably not shearing elements. The nonwoven plant is typically dimensioned such that the residence time of the TPU is as short as possible, i.e., <15 min, preferably <10 min and more preferably <5 min.

TPU is typically processed at between 180° C. and 220° C., depending on its hardness. Surprisingly, however, it has now emerged that TPU nonwovens are particularly efficient to produce when the processing temperatures are higher than the customary recommended processing temperatures. Preferably, the thermoplastic polyurethane is processed to form fibrous nonwoven web (ii) at the following temperatures:

For TPU having a Shore Hardness Between 75 A and 85 A:

The temperature of the adapter is preferably between 180° C. and 240° C. and more preferably between 200° C. to 240° C.

The temperature of the head is preferably between 180° C. and 240° C. and more preferably between 200° C. to 240° C.

The temperature of the nozzle is preferably between 180° C. to 240° C. and more preferably between 200° C. to 240° C.

For TPU having a Shore Hardness Between 90 A and 98 A:

The temperature of the adapter is preferably between 200° C. and 260° C. and more preferably between 220° C. and 250° C.

The temperature of the head is preferably between 200° C. and 260° C. and more preferably between 220° C. and 250° C.

The temperature of the nozzle is preferably between 200° C. and 260° C. and more preferably between 220° C. and 250° C.

Typically, the capillaries in the spinning manifold have a diameter between 0.3 mm and 0.6 mm. In the production of the fibers, these can be cooled with secondary air. Cooling with secondary air is not preferred, however.

Particular preference is given to a laminate wherein the thermoplastic polyurethane of said film (i) and of said fibrous nonwoven web (ii) is based on the same isocyanates (a), diols (b) having a number average molecular weight between 500 and 10,000 g/mol and chain extenders (c).

The laminate can be produced by direct extrusion of a film (i) onto the TPU web (ii). In the process, the web is preferably coated directly with TPU melt using a wide-slot die. The wide-slot die is preferably supplied by an extruder. The TPUs used for this preferably have an MFR (190° C./21.6 kg) between 20 and 100 g/10 min and preferably between 40 and 80 g/10 min. After the melt has been laid down on the web, the material preferably passes through a pair of (calender) rolls which additionally compresses the bond. The rolls may selectively be structured or smooth and if appropriate have an anti-stick coating.

However, it is preferable to produce a TPU film (i) and to subsequently laminate the TPU film (i) onto the TPU web (ii). To this end, the web (ii) and the film (i) are preferably superposed and pressed together by means of pressure and heat. It is preferable here to choose the two pressure and heat parameters such that the film is not destroyed and leakiness is therefore avoided. At the same time, however, a good bond between film (i) and web (ii) is desired.

The present invention thus also provides the process for producing a laminate comprising bonded together adheringly film (i) based on a thermoplastic polyurethane based on a polyetherdiol prepared by alkoxylation of a difunctional starting substance, ethylene oxide being used as alkylene oxide and the weight fraction of ethylene oxide based on the total weight of the alkylene oxides used being at least 20% by weight, and also fibrous nonwoven web (ii) based on thermoplastic polyurethane, which comprises pressing said film based on thermoplastic polyurethane and said fibrous nonwoven web (ii) based on thermoplastic polyurethane together at a temperature between 60° C. and 140° C., preferably between 70° C. and 120° C. and more preferably between 80° C. and 110° C.

The lineal pressing force is preferably between 1 N/mm and 300 N/mm, more preferably between 5 N/mm and 100 N/mm and particularly between 10 N/mm and 60 N/mm.

The laminate of the present invention is preferably produced by in-line lamination of the web with the film. In this preferred embodiment, the web (ii), i.e., the nonwoven, will be fabricated on a foraminous belt and then directly passed through a calender into which the film (i) is fed. This saves rewinding the TPU nonwoven. In addition, the adhesion of the film to the freshly produced nonwoven is better than to a nonwoven which has been stored for a prolonged period. It is thus preferable to produce the web by the meltblown process and for it subsequently to be pressed together with the film, preferably immediately after the production of the web. It is also possible to use calenders with gravure. Preference is given to using gravure calenders wherein the contact area is between 10 and 100%, preferably between 30 and 70% and particularly between 30 and 50%.

The breaking extension of the laminate is typically at least 100%, preferably greater than 150% and more preferably greater than 200%. The tensile strength of the laminate is preferably at least 5 N/5 cm, more preferably between 5 N/5 cm and 10,000 N/5 cm, more preferably between 10 N/5 cm and 2000 N/5 cm and even more preferably between 20 N/5 cm and 2000 N/5 cm.

1. A laminate comprising bonded together adheringly
(i) a thermoplastic polyurethane film based on a polyetherdiol prepared by alkoxylation of a difunctional starting substance comprising ethylene oxide as an alkylene oxide and the weight fraction of ethylene oxide based on the total weight of the alkylene oxides used being at least 20% by weight, and
(ii) a fibrous nonwoven web based on thermoplastic polyurethane.

2. The laminate according to claim 1 wherein said film (i) is based on the reaction of (a) an isocyanate with a polyetherdiol prepared by alkoxylation of a difunctional starting substance comprising ethylene oxide and propylene oxide as alkylene oxides.

3. The laminate according to claim 1 wherein said film (i) is based on the reaction of (a) an isocyanate with a polyetherdiol prepared by alkoxylation of difunctional starting substances comprising ethylene oxide as the sole alkylene oxide.

4. The laminate according to claim 1 wherein said film (i) is based on the reaction of (a) 4,4′-diphenylmethane diisocyanate with (b) a polyetherdiol and (c) butanediol.

5. The laminate according to claim 1 wherein said film (i) is between 10 μm and 200 μm thick.

6. The laminate according to claim 1 wherein said film (i) has a hardness between 60 Shore A and 74 Shore D.

7. The laminate according to claim 1 wherein said thermoplastic polyurethane film (i) is water vapor permeable.

8. The laminate according to claim 1 wherein more than 50% by weight of the total weight of the fibrous constituents of the fibrous nonwoven web (ii) consists of fibers having a length to diameter ratio of greater than 300.

9. The laminate according to claim 1 wherein the fibers of the fibrous nonwoven web (ii) are between 100 μm and 0.1 μm in diameter.

10. The laminate according to claim 1 wherein said fibrous nonwoven web (ii) has a thickness between 0.01 mm and 5 mm, measured according to ISO 9073-2.

11. The laminate according to claim 1 wherein said fibrous nonwoven web (ii) has a mass per unit area between 10 g/m² and 1000 g/m², measured according to ISO 9073-1.

12. The laminate according to claim 1 wherein the thermoplastic polyurethane on which said fibrous nonwoven web (ii) is based has a hardness between 50 Shore A and 54 Shore D.

13. The laminate according to claim 1 wherein the thermoplastic polyurethane of said film (i) and of said fibrous nonwoven web (ii) is based on the same isocyanates (a), diols (b) having a number average molecular weight between 500 and 10,000 g/mol and chain extenders (c).

14. A garment comprising a laminate according to claim 1.

15. Footwear comprising a laminate according to claim 1.

16. A medical/medicinal article comprising a laminate according to claim 1.

17. A process for producing a laminate comprising bonded together adheringly
(i) a thermoplastic polyurethane film based on a polyetherdiol prepared by alkoxylation of a difunctional starting substance comprising ethylene oxide as an alkylene oxide and the weight fraction of ethylene oxide based on the total weight of the alkylene oxides used being at least 20% by weight, and
(ii) a fibrous nonwoven web based on thermoplastic polyurethane composite material,
which process comprises pressing said film (i) based on thermoplastic polyurethane and said fibrous nonwoven web (ii) based on thermoplastic polyurethane together at a temperature between 60° C. and 140° C.

18. The process according to claim 17 wherein the lineal pressing force is between 1 N/mm and 300 N/mm.

19. The process according to claim 17 wherein the laminate is produced by in-line lamination of said fibrous nonwoven web with said film.

20. The process according to claim 17 wherein said fibrous nonwoven web is produced by the meltblown process and is then directly pressed together with said film.

21. The process according to claim 17 for producing a laminate according to claim 1.
